(19) United States
(12) Patent Application Publication
(10) Pub. No.: US 2021/0264503 A1
(43) Pub. Date: Aug. 26, 2021

(54) SALES MANAGEMENT SYSTEM, SALES MANAGEMENT DEVICE, AND CONTROL METHOD OF SALES MANAGEMENT DEVICE

(71) Applicant: TOSHIBA TEC KABUSHIKI KAISHA, Tokyo (JP)

(72) Inventor: Noriyoshi HARA, Mishima Shizuoka (JP)

(21) Appl. No.: 17/108,924

(22) Filed: Dec. 1, 2020

(30) Foreign Application Priority Data
Feb. 26, 2020 (JP) 2020-030048

(51) Int. Cl. G06Q 30/06; G10L 13/027; G06K 9/00; G06Q 20/40

(52) U.S. Cl. CPC G06Q 30/0637; G10L 13/027; G06Q 30/0641; G06K 9/00771; G06Q 20/4014; G06K 9/00362; G06K 9/00288

(57) ABSTRACT

A sales management system includes a monitoring device configured to determine one or more items that have been taken by one or more customers in a particular area of a store, capture an image of said one or more customers, and transmit data of the captured image and the determined items. The system further includes a sales management device configured to, upon receipt of the data from the monitoring device, identify one or more customers in the image, register the item indicated by the data as an item to be purchased by the customer when one customer is in the image, and issue an error signal that causes the monitoring device to output a registration error warning when two or more customers are in the image.

### CROSS-REFERENCE TO RELATED APPLICATION

This application is based upon and claims the benefit of priority from Japanese Patent Application No. 2020-030048, filed on Feb. 26, 2020, the entire contents of which are incorporated herein by reference.

### FIELD

Embodiments described herein relate generally to a sales management system, a sales management device of the sales management system, and a control method of the sales management device.

### BACKGROUND

Various sales management systems that enable merchandise displayed in a store to be checked out without involvement of a store clerk are devised.

Such sales management systems track a customer's actions using a large number of cameras installed in the store and also monitors merchandise on a display shelf or the like using a sensor. Then, the sales management system identifies a customer (from an image from the camera) who has taken (picked up) an item of merchandise from the display shelf for purchase. The removal of the item of merchandise from the display shelf can be detected based on a signal from the sensor. When the customer and item are identified, the item is registered as an item being purchased in a sales transaction for the customer. The sales management system performs settlement processing for the customer based on the items registered.

In such a sales management system, for example, when two customers each take an item of merchandise displayed on one merchandise shelf at almost at the same time, it may be difficult for the system to which customer has taken which item. In existing sales management systems, often one of the customers will be identified as the purchaser of both removed items, and the sales transaction data may not be processed properly. For that reason, customers have to be advised not to take an item of merchandise at the same time as another customer.

### BRIEF DESCRIPTION OF THE DRAWINGS

FIG. 1 is a block diagram illustrating a sales management system according to an embodiment.

FIG. 2 is a block diagram illustrating a gate device in a sales management system.

FIG. 3 is a block diagram illustrating a person tracking device in a sales management system.

FIG. 4 is a schematic diagram illustrating a data structure of a tracking file stored in a person tracking device.

FIG. 5 is a block diagram illustrating a monitoring device in a sales management system.

FIG. 6 is a schematic view illustrating a positional relationship of devices disposed at a merchandise display place.

FIG. 7 is a schematic diagram illustrating a positional relationship of devices disposed at a merchandise display place.

FIG. 8 is a schematic diagram illustrating a data structure of a monitoring table stored in a monitoring device.

FIG. 9 is a schematic diagram illustrating variation data output from a monitoring device to a sales management device.

FIG. 10 is a block diagram illustrating a sales management device in a sales management system.

FIG. 11 is a schematic diagram illustrating a data structure of a conversion table stored in a sales management device.

FIG. 12 is a schematic diagram illustrating a purchase list included in a sales management device.

FIG. 13 is a flowchart of main information processing executed by a sales management device.

FIG. 14 is a flowchart of merchandise return processing.

FIG. 15 is a flowchart of merchandise return processing.

### DETAILED DESCRIPTION

Certain embodiments provide a highly reliable sales management systems that can manage sales data even when it is difficult to specify the particular customer who has taken an item of merchandise.

In general, according to one embodiment, a sales management system includes a monitoring device. The monitoring device is configured to determine one or more items that have been taken by one or more customers in a particular area of a store, capture an image of the one or more customers, and transmit data of the captured image and the determined items. The system further includes a sales management device. The sales management device is configured to, upon receipt of the data from the monitoring device, identify the one or more customers in the image, register the item indicated by the data as an item to be purchased by the customer when one customer is in the image, and issue an error signal that causes the monitoring device to output a registration error warning when two or more customers are in the image.

Hereinafter, one or more embodiments of a sales management system and a sales management device will be described with reference to the accompanying drawings.

Those embodiments relate to a sales management system that identifies a customer who picks up an item of merchandise from a display shelf or other location as an intended purchaser of the picked up item whenever the item is detected as being picked up and then registers the picked up item on a purchase list specified particularly for the customer. In general, with a sales management system of this type, an error must be notified if a plurality of customers pick up items from the same display place at the same time so that erroneous sales data will not be registered.

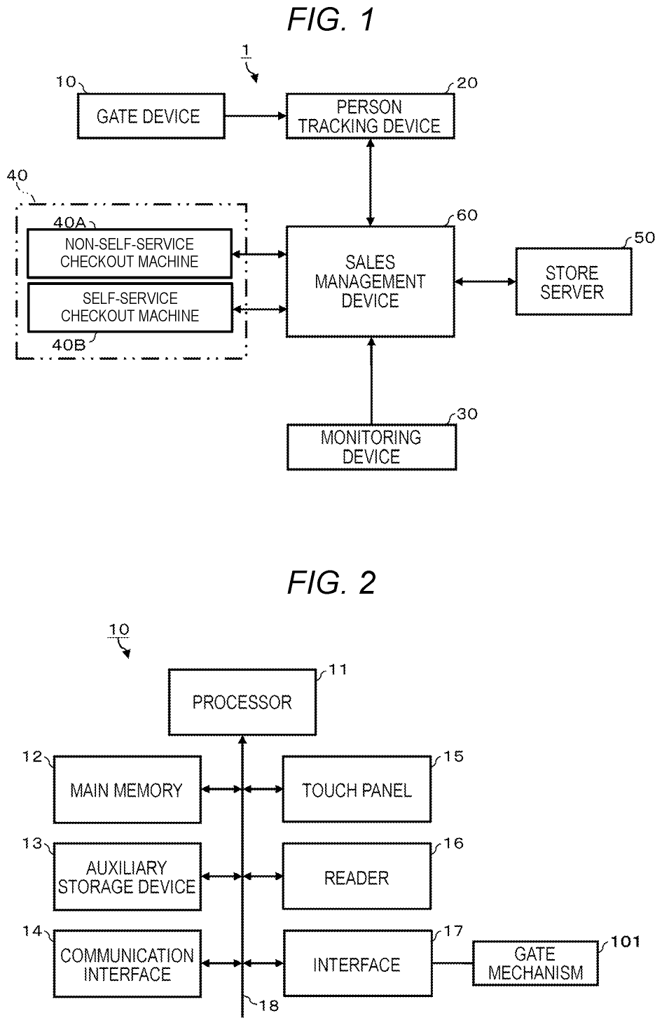

FIG. 1 is a block diagram illustrating a sales management system 1 according to an embodiment. The sales management system 1 includes a gate device 10, a person tracking device 20, a monitoring device 30, a plurality of checkout machines 40, a store server 50, and a sales management device 60. The gate device 10 is connected to the person tracking device 20 via a network such as a local area network (LAN). The person tracking device 20, the monitoring device 30, the checkout machine 40, and the store server 50 are also connected to the sales management device via a network. The gate device 10 may be further connected to at least one of the store server 50 and the sales management device 60 by the network. The LAN may be a wired LAN or a wireless LAN.

Next, the gate device 10, the person tracking device 20, the monitoring device 30, the checkout machine 40, and the store server 50 will be described in order.

The gate device 10 receives a check-in operation for a customer who is entering a store. Then, the gate device 10 is in an open state that allows the customer to enter the store or a closed state that prevents the customer from entering the store.

FIG. 2 is a block diagram illustrating the gate device 10. The gate device 10 includes a processor 11, a main memory 12, an auxiliary storage device 13, a communication interface 14, a touch panel 15, a reader 16, an interface 17, a system transmission line 18, and a gate mechanism 101. The gate mechanism 101 is connected to the interface 17. The processor 11, the main memory 12, the auxiliary storage device 13, the communication interface 14, the touch panel 15, the reader 16, and the interface 17 are connected to each other via the system transmission line 18. The system transmission line 18 includes an address bus, a data bus, a control signal line, and the like. In the gate device 10 according to one embodiment, the processor 11, the main memory 12, and the auxiliary storage device 13 are connected by the system transmission line 18 to make up a controller that performs information processing for controlling the gate device 10.

The processor 11 controls each unit of the gate device 10 to perform various functions according to one or more programs. The processor 11 is, for example, a central processing unit (CPU).

The main memory 12 includes a non-volatile memory area and a volatile memory area. The main memory 12 stores an operating system and/or one or more application programs in the non-volatile memory area. The main memory 12 stores data necessary for the processor 11 to control each unit of the gate device 10 in a volatile memory area. The volatile memory area is a work area in which data is temporarily stored by the processor 11. The non-volatile memory area is, for example, a read only memory (ROM). The volatile memory area is, for example, a random access memory (RAM).

The auxiliary storage device 13 is a well-known storage device, such as an electric erasable programmable read-only memory (EEPROM), a hard disc drive (HDD), or a solid state drive (SSD), or any combination thereof. The auxiliary storage device 13 stores data used by the processor 11 for performing various types of processing and data generated by the processor 11. The auxiliary storage device 13 may store one or more application programs.

The communication interface 14 is an interface circuit through which data is communicated with another device connected via a network.

The touch panel 15 displays a screen for presenting various types of information to an operator of the gate device 10. Then, the touch panel 15 receives a touch operation on the screen by the operator as an input. The operator of the gate device 10 is a customer in most cases, but a store clerk may be the operator.

The reader 16 reads a customer ID presented by the customer who visits the store. The customer ID is a unique identification code assigned to a registered customer. The customer ID is displayed in a form of a barcode on the display of a smartphone owned by the customer, for example. In such a case, the reader 16 operates as a bar code reader. The customer ID may be stored in an IC chip of a card medium distributed to the customer, for example. In such a case, the reader 16 becomes an IC card reader.

The interface 17 outputs an opening instruction signal or a closing instruction signal to the gate mechanism 101. The gate mechanism 101 includes a gate that opens or closes according to the signals, and a sensor for detecting a customer passing through the gate, that is, a gate passage sensor. The gate passage sensor is, for example, an optical sensor. The gate mechanism 101 opens the gate in response to the opening instruction signal. The gate mechanism 101 closes the gate in response to the closing instruction signal. The gate mechanism 101 outputs a detection signal of the gate passage sensor to the interface 17. The interface 17 receives the detection signal of the gate passage sensor and outputs the detection signal to the processor 11.

In the gate device 10 having such a configuration, when the customer ID is read by the reader 16, the processor inquires about validity of the customer ID via the communication interface 14. An inquiry destination is, for example, the store server 50. When the customer ID is validated, the processor 11 controls the gate mechanism 101 to open the gate, and notifies the person tracking device 20 of the customer ID via the communication interface 14. The gate is opened to allow the customer to enter the store. When the customer ID is not validated, the processor 11 causes the touch panel 15 to display an image for notifying the customer of refusal to enter the store. The processor 11 controls the gate mechanism 101 to close the gate, which prevents the customer from entering the store.

Although only one gate device 10 is illustrated in FIG. 1, any number of gate devices 10 may be installed in a store and included in the sales management system 1.

The person tracking device 20 is for tracking movements of a customer who has entered the store through the gate. The person tracking device 20 monitors the movement and actions of the customer by analyzing images captured by a large number of cameras attached to the ceiling of the store or the like.

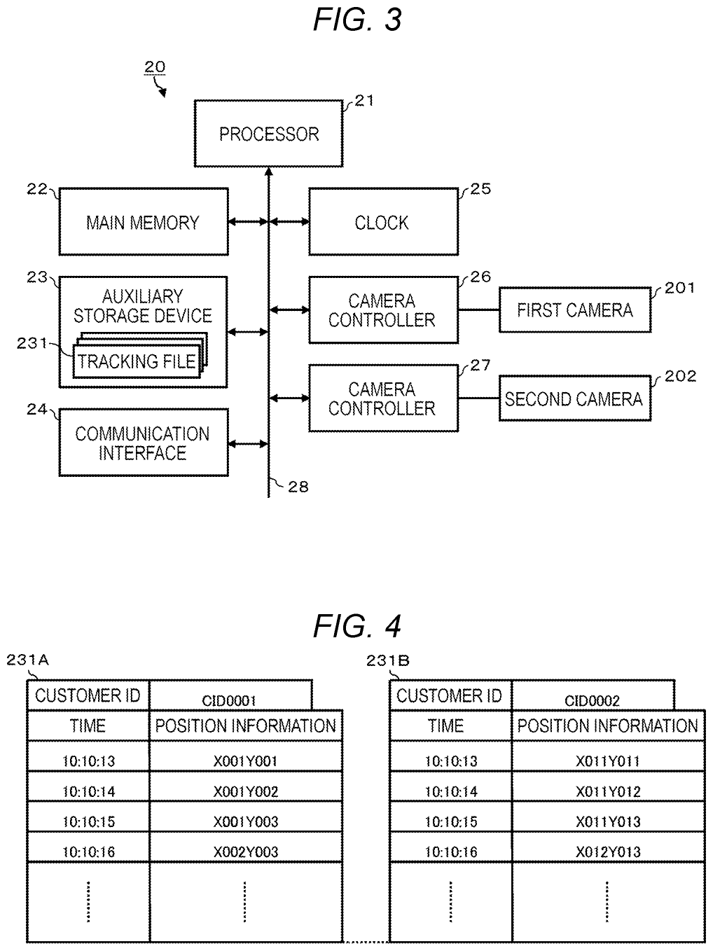

FIG. 3 is a block diagram illustrating the person tracking device 20. The person tracking device 20 includes a processor 21, a main memory 22, an auxiliary storage device 23, a communication interface 24, a clock 25, a first camera controller 26, a second camera controller 27, a system transmission line 28, a first camera 201 and a second camera 202. The first camera 201 is connected to the first camera controller 26. The second camera 202 is connected to the second camera controller 27. The processor 21, the main memory 22, the auxiliary storage device 23, the communication interface 24, the clock 25, the first camera controller 26, and the second camera controller 27 are connected to each other via the system transmission line 28. The system transmission line 28 includes an address bus, a data bus, a control signal line, and the like. In the person tracking device 20, the processor 21, the main memory 22, and the auxiliary storage device 23 are connected to each other via the system transmission line 28 to make up a controller for controlling the person tracking device 20.

The processor 21, the main memory 22, the auxiliary storage device 23, and the communication interface 24 have similar functions as the processor 11, the main memory 12, the auxiliary storage device 13, and the communication interface 14 of the gate device 10.

The clock 25 is a real time clock circuit. The processor 21 acquires the current time from the clock 25.

The first camera controller 26 controls the first camera 201 to capture an image. The first camera 201 is a camera for photographing the vicinity of the gate of the gate device 10. The first camera 201 functions as a customer specifying camera for specifying a customer who passes through the gate. The first camera 201 is disposed in the vicinity of the gate. The first camera 201 is, for example, an optical camera. An infrared camera, a time of flight (TOF) camera, a stereo camera, or the like may be used as the first camera 201.

The second camera controller 27 controls the second camera 202 to capture an image. The second camera 202 is a camera for photographing the entire area of the store. The second camera 202 functions as a customer tracking camera for tracking a customer moving in the store. A plurality of second cameras 202 are disposed on the ceiling of the store or the like. The second camera 202 is, for example, an optical camera. An infrared camera, a TOF camera, a stereo camera, and the like may be used as the second camera 202.

In the person tracking device 20 having such a configuration, when the customer ID is received by the gate device 10 and validated, the processor 21 generates a tracking file 231 in association with the customer ID and stores the tracking file 231 in the auxiliary storage device 23. The processor 21 recognizes a person who has passed through the gate of the gate device 10 from the image captured by the first camera 201, and specifies the person as a customer having the customer ID. Then, the processor 21 tracks the customer having the customer ID from the image captured by the second camera 202. The processor 21 acquires position information of the customer, for example, every one second, and stores the time and the position information in time series in the tracking file 231 associated with the customer ID. The position information is specified by an XY coordinate, which is obtained, for example, by setting any point of a floor surface of the store as the origin O on the XY-plane and dividing the surface into a predetermined number of regions in the X and Y directions.

FIG. 4 is a schematic diagram illustrating a data structure of the tracking file 231 (231A and 231B). As illustrated in FIG. 4, in the tracking file 231 (231A and 231B), a customer ID and paired data of time and position information are described. The paired data is described in time series. The paired data is a movement locus of the customer specified by the customer ID in the store. That is, in FIG. 4, the tracking file 231A is a data file in which the movement of the customer whose customer ID is “CID0001” is recorded. The tracking file 231B is a data file in which the movement of the customer whose customer ID is “CID0002” is recorded.

The monitoring device 30 is a device that monitors a display place of merchandise such as a merchandise shelf, a merchandise case, a sales space, and the like. The monitoring device 30 has a function of detecting a decrease or increase in merchandise displayed at the display place, and a function of monitoring a merchandise handling action by the customer at the display place. The merchandise handling action includes an action of picking up merchandise from the display place. Hereinafter, such an action will be referred to as a purchase action. The merchandise handling action includes an action of returning the item to the display place. Hereinafter, such an action will be referred to as a merchandise returning action. The monitoring device 30 monitors the purchase action and the merchandise returning action by a customer.

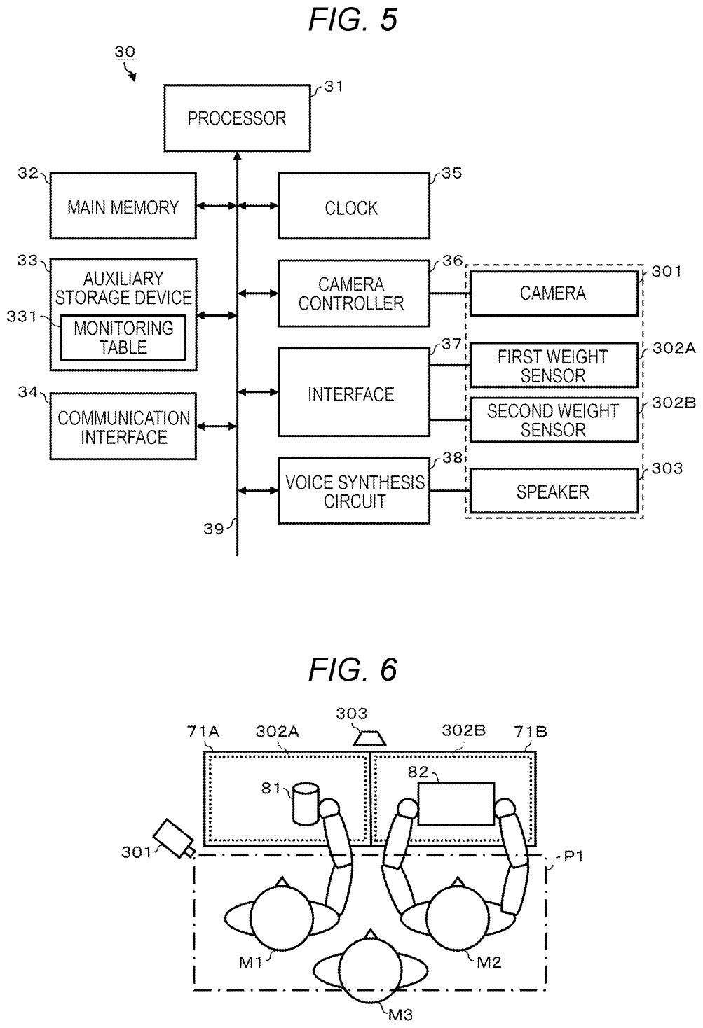

FIG. 5 is a block diagram illustrating the monitoring device 30. The monitoring device 30 includes a processor 31, a main memory 32, an auxiliary storage device 33, a communication interface 34, a clock 35, a camera controller 36, an interface 37, a voice synthesis circuit 38, a system transmission line 39, a camera 301, a first weight sensor 302A, a second weight sensor 302B, and a speaker 303. The camera 301 is connected to the camera controller 36. The first weight sensor 302A and the second weight sensor 302B are connected to the interface 37. The speaker 303 is connected to the voice synthesis circuit 38. The processor 31, the main memory 32, the auxiliary storage device 33, the communication interface 34, the clock 35, the camera controller 36, the interface 37, and the voice synthesis circuit 38 are connected to each other via the system transmission line 39. The system transmission line 39 includes an address bus, a data bus, a control signal line, and the like. In the monitoring device 30, the processor 31, the main memory 32, and the auxiliary storage device 33 are connected to each other via the system transmission line 39 to make up a controller for controlling the monitoring device 30.

The processor 31, the main memory 32, the auxiliary storage device 33, the communication interface 34, and the clock 35 have similar functions as the processor 21, the main memory 22, the auxiliary storage device 23, the communication interface 24, and the clock 25 of the person tracking device 20.

The camera controller 36 controls the camera 301 to capture an image and stores the image in the main memory 32. The image is stored in the volatile area of the main memory 32, for example. The processor 31 monitors the merchandise handling action by the customer, that is, the purchase action or the merchandise returning action, based on the stored image. The customer extends one or both arms to a display place of merchandise when performing the purchase action or performing the merchandise returning action. The processor 31 recognizes the action by the customer extending his or her arm to the display place of the merchandise as the merchandise handling action.

The interface 37 receives a measurement signal from each of the first weight sensor 302A and the second weight sensor 302B. The measurement signal is then output to the processor 31. The processor 31 obtains a weight value measured by the first weight sensor 302A from the measurement signal. The processor 31 obtains a weight value measured by the second weight sensor 302B from the measurement signal. The processor 31 detects a decrease or increase in the number of items of merchandise displayed at the display place based on variation in the weight value measured by each of the first weight sensor 302A and the second weight sensor 302B.

The voice synthesis circuit 38 generates voice data and outputs the voice data to the speaker 303. The speaker 303 emits a voice sound according to the generated voice data.

In an embodiment, a set of the camera 301, the first weight sensor 302A and the second weight sensor 302B, and the speaker 303 is disposed in correlation with two merchandise display places that are close together.

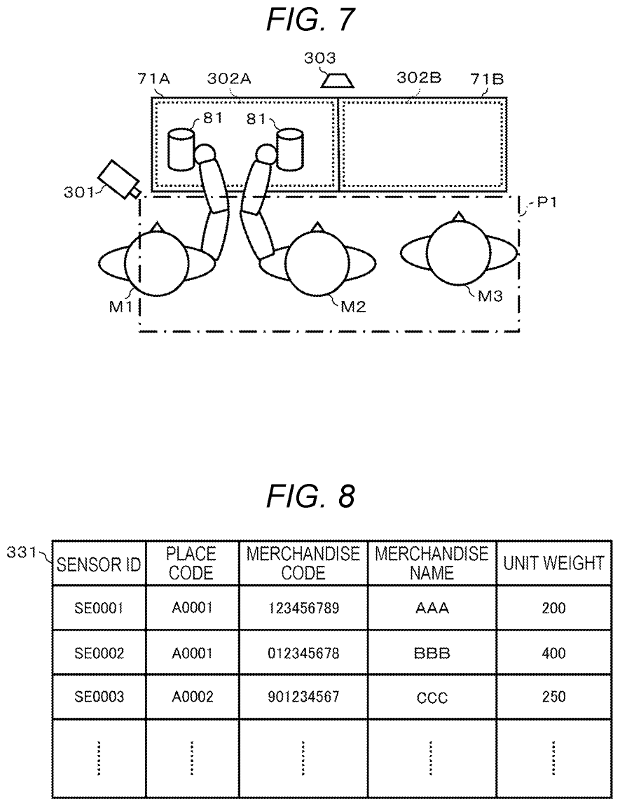

FIGS. 6 and 7 are schematic diagrams illustrating a positional relationship between one set of the camera 301, the first weight sensor 302A, the second weight sensor 302B, and the speaker 303 disposed at two merchandise display places 71A and 71B. In the following, one merchandise display place 71A is referred to as a first display place 71A, and the other merchandise display place 71B is referred to as a second display place 71B.

As illustrated in FIGS. 6 and 7, the first display place 71A and the second display place 71B are adjacent to each other on the floor. Merchandise 81 is displayed at the first display place 71A. Merchandise 82 is displayed at the second display place 71B. The camera 301 is disposed at a position where a customer in the vicinity of the first display place 71A or the second display place 71B can be photographed. The camera 301 is, for example, a digital video camera. An optical camera, an infrared camera, a TOF camera, a stereo camera, and the like may be used as the camera 301.

The first weight sensor 302A is disposed at the first display place 71A. The first weight sensor 302A weighs the total weight of items of merchandise 81 displayed at the first display place 71A. The second weight sensor 302B is disposed at the second display place 71B. The second weight sensor 302B weighs the total weight of items of merchandise 82 displayed at the second display place 71B.

The speaker 303 is disposed at a place where the customer in the vicinity of the first display place 71A or the second display place 71B can easily hear the voice sound. In FIGS. 6 and 7, the speaker 303 is disposed between the first display place 71A and the second display place 71B.

FIG. 6 illustrates a scene in which a customer M1 picks up a piece of merchandise 81 with his or her right hand and at the same time a customer M2 picks up another piece of merchandise 82 with his or her both hands when there are three customers M1, M2, and M3 within the imaging area of the camera 301. On the other hand, FIG. 7 illustrates a scene in which the customer M1 picks up the merchandise 81 with his or her right hand and at the same time the customer M2 picks up the same merchandise 81 with his or her left hand. That is, in both FIG. 6 and FIG. 7, two customers M1 and M2 are performing merchandise handling actions. The customer M3 is not taking any merchandise handling action.

In the monitoring device 30, a plurality of sets of the cameras 301, the first weight sensors 302A, the second weight sensors 302B, and the speakers 303 are connected to the camera controller 36, the interface 37, and the voice synthesis circuit 38. The monitoring device 30 stores a monitoring table 331 in the auxiliary storage device 33.

FIG. 8 is a schematic diagram illustrating the monitoring table 331. As illustrated, the monitoring table 331 includes a sensor ID field, a place code field, a merchandise code field, a merchandise name field, and a unit weight field.

In the sensor ID field, a sensor ID of the first weight sensor 302A or the second weight sensor 302B connected to the interface 37 is described. In the first weight sensor 302A and the second weight sensor 302B of each set, a unique sensor ID is set in advance.

In the place code field, a place code of the first display place 71A or the second display place 71B in which the first weight sensor 302A or the second weight sensor 302B specified by the corresponding sensor ID is disposed is described. For each display place, a unique place code is set in advance. However, for the first display place 71A or the second display place 71B of the same set, the same place code is set.

In the merchandise code field, a merchandise code of merchandise whose total weight is measured by the first weight sensor 302A or the second weight sensor 302B identified by the corresponding sensor ID is described. For each piece of merchandise, a unique merchandise code is set in advance. Then, in the unit weight field, the weight per piece of merchandise identified by the merchandise code is described.

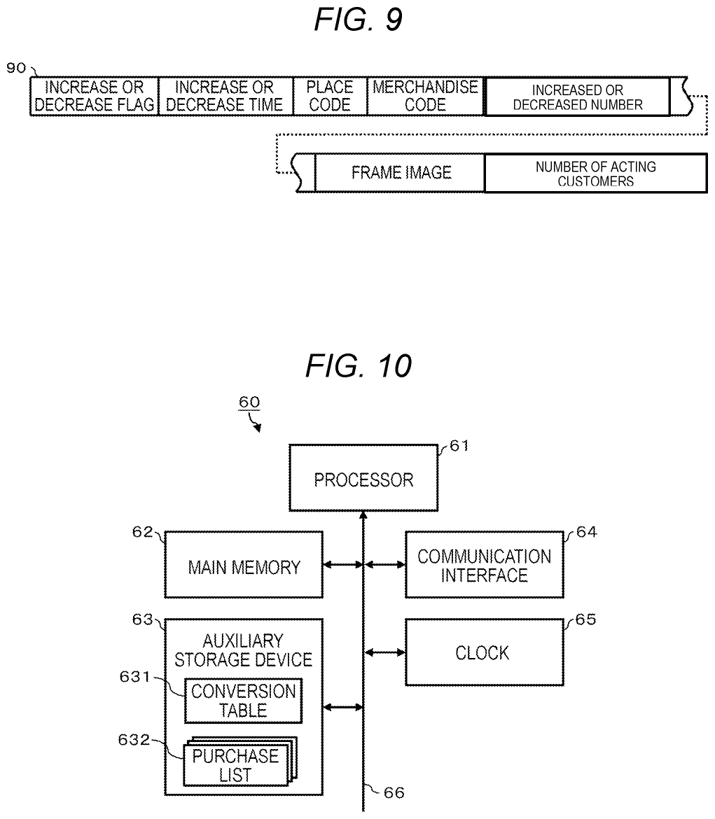

In the monitoring device 30 having such a configuration, every time the measurement value of the first weight sensor 302A or the second weight sensor 302B varies by the unit weight or more corresponding to the sensor ID of the first weight sensor 302A or the second weight sensor 302B, variation data 90 (see FIG. 9) is output to the sales management device 60.

FIG. 9 is a schematic diagram illustrating the variation data 90. As illustrated, the variation data 90 includes an increase or decrease flag, an increase or decrease time, a place code, a merchandise code, the increased or decreased number of items, a frame image, the number of acting customers, and the like.

The increase or decrease flag is 1-bit data for identifying whether the measurement value is decreased or increased. In an embodiment, when the measurement value decreases the increase or decrease flag is set to “0”, and when the measurement value increases the increase or decrease flag is set to “1”. The increase or decrease time is the time of the clock 35 at the time when the measurement value fluctuates by the unit weight or more. The place code and the merchandise code are the place code and the merchandise code which are set in the monitoring table 331 in correlation with the sensor ID of the first weight sensor 302A or the second weight sensor 302B whose measurement value varies by more than the unit weight. The increased or decreased number of items is an integer of the quotient when the measurement value is divided by the unit weight. The frame image is an image photographed by the camera 301 at the time when the measurement value varies by the unit weight or more. The number of acting customers is the number of customers who are recognized as performing a merchandise handling action at the first display place 71A or the second display place 71B.

The checkout machine 40 is a terminal for settling a commercial transaction with a customer. The checkout machine 40 can settle the commercial transaction by a well-known settlement method such as cash settlement, credit card settlement, electronic money settlement, point settlement, and code settlement (also referred to as mobile settlement or smartphone settlement).

The checkout machine 40 includes a non-self-service checkout machine 40A that allows a store clerk to input information for settlement, and a self-service checkout machine 40B that allows a customer to input information for settlement. As the non-self-service checkout machine 40A, a conventionally known point of sale (POS) terminal can be applied. As the self-service checkout machine 40B, a known self-service-type or semi-self-service-type checkout machine of the related art can be applied.

The store server 50 manages various databases such as a merchandise database and a member database. The merchandise database is an aggregate of merchandise records describing data of each piece of merchandise sold in the store. The merchandise record is composed of data items such as a merchandise code, a merchandise name, and a price. The member database is an aggregate of member records in which data about a registered customer (i.e., a member) is described. The member record includes data items such as a customer ID, a validity period, and earned points. The validity period indicates the validity period as a member. The validity period may be specified by the start date and the end date of the period, or the start date and the effective period. The earned points indicate points that have been earned by the member's purchase in the store.

When the store server 50 receives an inquiry about validity of the customer ID by the check-in operation in the gate device 10, the store server 50 retrieves the member database. Then, the store server 50 specifies the valid period of a member record including the customer ID for which inquiry is being made. When the current date and time is within the valid period, the store server 50 returns a response indicating that the customer ID is valid to the gate device 10. When the current date and time is outside the valid period, the store server 50 returns the response indicating that the customer ID is invalid to the gate device 10. The validity of the customer ID may be made further based on a blacklist in which customers who are not allowed to enter the store are listed.

Finally, the sales management device 60 will be described.

The sales management device 60 manages data relating to purchase merchandise for a customer whose ID is validated through the check-in operation by the gate device 10 and is being tracked by the person tracking device 20. Then, the sales management device 60 has a function of generating checkout data based on the data and outputting the checkout data to the checkout machine 40.

FIG. 10 is a block diagram illustrating the sales management device 60. The sales management device 60 includes a processor 61, a main memory 62, an auxiliary storage device 63, a communication interface 64, a clock 65, and a system transmission line 66. The processor 61, the main memory 62, the auxiliary storage device 63, the communication interface 64, and the clock 65 are connected to each other via the system transmission line 66. The system transmission line 66 includes an address bus, a data bus, a control signal line, and the like. In the sales management device 60, the processor 61, the main memory 62, and the auxiliary storage device 63 are connected to each other via the system transmission line 66 to make up a controller for controlling the sales management device 60.

The processor 61 controls each unit of the sales management device 60 to perform various functions as the sales management device 60 according to one or more programs. The processor 61 is, for example, a CPU.

The main memory 62 includes a non-volatile memory area where an operating system or one or more application programs are stored and a volatile memory area where data necessary for the processor 61 to control each unit of the sales management device 60. The volatile memory area is a work area in which data is temporarily stored by the processor 61. The non-volatile memory area is, for example, a ROM. The volatile memory area is, for example, a RAM.

The auxiliary storage device 63 is a well-known storage device, such as the EEPROM, HDD or SSD, or any combination thereof. The auxiliary storage device 63 stores data used by the processor 61 for performing various types of processing and data generated by the processor 61. The auxiliary storage device 63 may store one or more application programs.

The application programs stored in the auxiliary storage device 63 include a control program relating to sales management. A method of installing the control program in the auxiliary storage device 63 is not particularly limited. The control program can be installed in the auxiliary storage device 63 from a removable recording medium, or distributed via a network. The recording medium may be any type of medium, such as a CD-ROM or a memory card, as long as it can store the program and can be read by the device. The control program may be installed in the main memory 62 instead of the auxiliary storage device 63.

The communication interface 64 is an interface circuit through which data is communicated with another device connected via a network.

The clock 65 is a real time clock circuit. The processor 61 acquires the current time from the clock 25.

The sales management device 60 having such a configuration stores a conversion table 631 in the auxiliary storage device 63. The sales management device 60 uses a part of the auxiliary storage device 63 for storing a plurality of purchase lists 632.

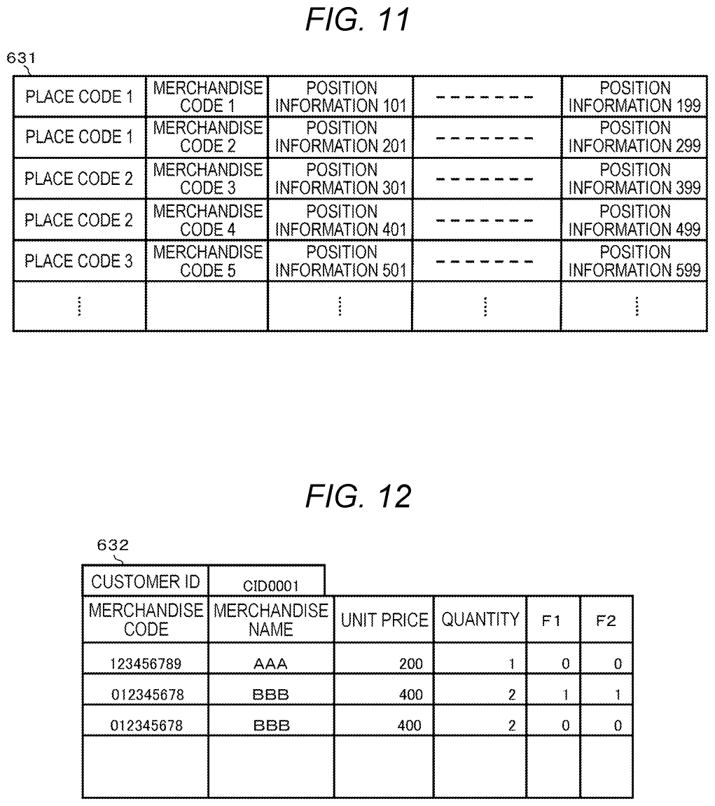

FIG. 11 is a schematic diagram illustrating a data structure of the conversion table 631. As illustrated in FIG. 11, the conversion table 631 stores a plurality of pieces of position information in association with a place code and a merchandise code. As described above, the place code is a unique identification code which is set for each display place in order to identify the display place for merchandise. The merchandise code is an identification code of merchandise displayed at the display place specified by the place code. Each of the plurality of pieces of position information indicates a potential position of a customer who is taking the merchandise displayed at the display place specified by the place code and the merchandise code. The position information is registered in the order of proximity to the display place. A table 631A similar to the conversion table 631 is also stored in the auxiliary storage device 23 of the person tracking device 20. In the conversion table 631A stored in the person tracking device 20, the merchandise code may be omitted.

FIG. 12 is a schematic diagram illustrating an example of a purchase list 632. As illustrated in the figure, the purchase list 632 includes an area for describing a customer ID and an area for describing a plurality of purchase records. The purchase record includes a merchandise code, a merchandise name, a unit price, a quantity, a temporary registration flag, and a deletion flag. The merchandise code, the merchandise name, the unit price, and the quantity are sales data of purchase merchandise, so-called merchandise sales data. The temporary registration flag is 1-bit data for identifying whether the purchase record is a temporary registration record or a final registration record. A difference between temporary registration and final registration will be described later. In an embodiment, the temporary registration flag of the purchase record for temporary registration is set to “1”, and the temporary registration flag of the purchase record for final registration is set to “0”. The deletion flag is 1-bit data for identifying whether the purchase record is in a deleted state. In an embodiment, the deletion flag of the purchase record in the deleted state is set to “1”, and the deletion flag of the purchase record in a non-deleted state is set to “0”.

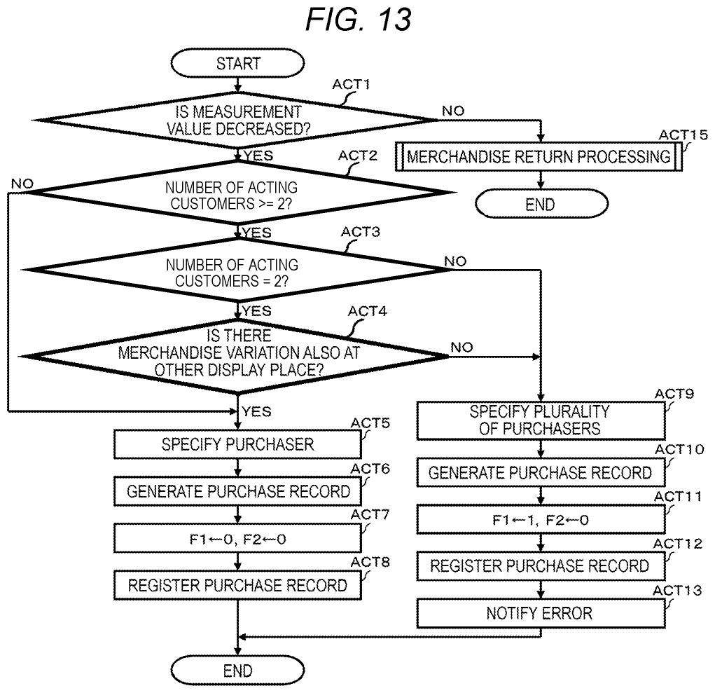

FIGS. 13 to 15 are flowcharts illustrating main information processing executed by the sales management device 60. In the following, an example of the operation of the sales management device 60 will be described with reference to each flowchart. Any other operation may be performed as long as similar results are obtained.

First, the operation performed when the sales management device 60 receives the variation data 90 in which the increase or decrease flag is set to “0”, that is, the measurement value decreases, will be described.

Upon receipt of the variation data 90 via the communication interface 64, the processor 61 starts information processing illustrated in the flowchart of FIG. 13. The processor 61 reads the increase or decrease flag of the variation data 90, as ACT 1. When the increase or decrease flag is “0”, the processor 61 determines that the result in ACT 1 is YES and proceeds to ACT 2. The processor 61 reads the number of acting customers of the variation data 90, as ACT 2. When the number of acting customers is one, the processor 61 determines that the result in ACT 2 is NO, and proceeds to ACT 5. Then, the processor 61 executes final registration processing, which will be described later, as ACT 5 to ACT 8.

When the number of acting customers is two or more, the processor 61 determines that the result in ACT 2 is YES, and proceeds to ACT 3. The processor 61 checks whether the number of acting customers is two, as ACT 3. When the number of acting customers is three or more, the processor 61 determines that the result in ACT 3 is NO, and proceeds to ACT 9. Then, the processor 61 executes temporary registration processing described later, as ACT 9 to ACT 13.

When the number of acting customers is two, the processor 61 determines that the result in ACT 3 is YES, and proceeds to ACT 4. The processor 61 check whether there is variation in merchandise at another display place having the same place code at approximately the same time, as ACT 4. Specifically, the processor 61 checks the presence or absence of other variation data 90x whose difference from the increase or decrease time of variation data 90 is less than a threshold time, for example, 2 seconds, and which is variation data 90x that matches the place code but does not match the merchandise code. When there is variation in merchandise at the other display place having the same place code at approximately the same time, the variation data 90x exists.

When the variation data 90x exists, the processor 61 determines that the result in ACT 4 is YES and proceeds to ACT 5. That is, the processor 61 executes the final registration processing. When the variation data 90x does not exist, the processor 61 determines that the result in ACT 4 is NO and proceeds to ACT 9. That is, the processor 61 executes the temporary registration processing.

Next, the final registration processing will be described.

The processor 61 specifies the purchaser, as ACT 5. Specifically, the processor 61 outputs a retrieval request command, which is transmitted to the person tracking device 20. The retrieval request command includes the increase or decrease time and the place code acquired from the variation data 90.

Upon receipt of the retrieval request command, the processor 21 of the person tracking device 20 retrieves the tracking file 231. Then, the processor 21 detects the customer ID whose position information correlated with the increase or decrease time is included in the position information group associated with the place code of the conversion table 631A. The detected customer ID is the customer ID of a customer who is near the first display place 71A or the second display place 72B identified by the place code at the increase or decrease time. The processor 21 outputs a response command, which is transmitted to the sales management device 60. The response command includes data in which the detected customer ID is associated with the position information stored in correlation with the increase or decrease time in the tracking file 231 in which the customer ID is set. When a plurality of customer IDs are detected, the response command includes data in which the customer ID is associated with the position information for each customer ID.

The processor 61 acquires data in which the customer ID is associated with the position information from the response command. When the number of pieces of acquired data is one, the processor 61 specifies the customer ID of the data as the customer ID of the purchaser. When two or more pieces of data are acquired, the processor 61 determines the position of the customer who performed the merchandise handling action from the frame image of the variation data 90. Then, the processor 61 specifies the customer ID associated with the position information closest to the estimated position as the customer ID of the purchaser.

Any other procedure may be used to specify the customer ID of the purchaser. When there is only one customer near the display place defined by the place code and the merchandise code, the customer ID of that customer is specified as the customer ID of the purchaser. When there are two customers at the same display place, the customer ID of the customer closer to the display place is specified as the customer ID of the purchaser.

Thus, if the customer ID of one purchaser is specified, the processor 61 generates a purchase record, as ACT 6. That is, the processor 61 acquires a merchandise name and unit price of merchandise specified by the merchandise code of the variation data 90 from the merchandise database. Then, the processor 61 generates the purchase record with the merchandise code, the merchandise name and the unit price, and the increased or decreased number of merchandise of the variation data 90. The processor 61 sets both temporary registration flag F1 and deletion flag F2 of the purchase record as “0”, as ACT 7. Thus, when the purchase data is generated, the processor 61 registers the purchase record in the purchase list 632 in which the customer ID of the purchaser is set, as ACT 8. Thus, the final registration processing ends.

Next, the temporary registration processing will be described.

The processor 61 specifies each of the customer IDs of a plurality of purchasers, as ACT 9. Specifically, the processor 61 outputs a retrieval request command, which is transmitted to the person tracking device 20, similarly to the final registration processing. With this configuration, a response command is output from the person tracking device 20 to the sales management device 60. In such a case, since a plurality of purchasers are assumed, the response command includes a plurality of pieces of data in which the customer ID and the position information are associated with each other.

The processor 61 determines each of the positions of the plurality of customers who performed the merchandise handling action from the frame images of the variation data 90. Then, the processor 61 specifies each of the customer IDs associated with the position information closest to the estimated position on a per estimated position basis, as the customer ID of each purchaser.

In this way, when each of the customer IDs of a plurality of purchasers is specified, the processor 61 generates the purchase record, as ACT 10. The processor 61 sets the temporary registration flag F1 of the purchase record to “1” and the deletion flag F2 to “0”, as ACT 11. In this way, when the purchase data is generated, the processor 61 registers each of the purchase records in the purchase list 632 in which the customer ID of each purchaser is set, as ACT 12.

Furthermore, the processor 61 performs error notification, as ACT 13. Specifically, the processor 61 outputs a voice signal for error notification to the monitoring device 30 via the communication interface 64. With this configuration, in the monitoring device 30, a voice sound for notifying an error is synthesized by the voice synthesis circuit 38, and the voice sound is emitted from the speaker 303.

The voice sound for error notification contains a message for notifying that a registration error occurs because a plurality of customers takes merchandise at the same time. For example, a message such as “an error has occurred. Please return merchandise.” is output from the speaker 303.

Thus, the temporary registration processing ends.

Here, by executing processing of ACT 1 to ACT 3, the processor 61 acquires the number of customers whose merchandise handling action is confirmed for the display place where the decrease in merchandise is detected. Specifically, the processor 61 acquires whether the number of customers whose merchandise handling action is confirmed is one, two, or three or more.

By executing processing of ACT 5 to ACT 8, when the number of customers whose merchandise handling action is confirmed is one, the processor 61 specifies the one customer as a purchaser, and registers the sales data of the merchandise for which a decrease is detected in the purchase list 632 of the customer specified as the purchaser.

By executing processing of ACT 3 and ACT 4, when the number of customers whose merchandise handling action is confirmed is two, the processor 61 determines whether a decrease or increase in merchandise displayed at the second display place, which is positioned in the vicinity of the first display place where the decrease in merchandise is detected, is detected.

By executing processing of ACT 4 to ACT 8, when the decrease or increase in merchandise displayed at the second display place is detected, the processor 61 specifies one of the two customers who is near the first display place as the purchaser and registers the sales data of the merchandise, whose decrease is detected at the first display place, in the purchase list 632 of the customer specified as the purchaser.

By executing processing of ACT 3, ACT 4, and ACT 13, when the decrease or increase in merchandise is not detected at the second display place or the number of customers whose merchandise handling action is confirmed is three or more, the processor 61 outputs a signal for notifying a registration error to the monitoring device 30. Then, the speaker 303 emits a voice sound for notifying the registration error.

For example, in FIG. 6, it is assumed that only the customer M1 performs a purchase action to pick up one piece of merchandise 81 displayed at the first display place 71A. In such a case, the variation data 90A is output from the monitoring device 30 to the sales management device 60. In the variation data 90A, the increase or decrease flag is set to “0”. The variation data 90A includes a place code commonly set for the first display place 71 and the second display place 72, and a merchandise code of the merchandise 81. The increased or decreased number of merchandise is “1”, and the number of acting customers is also “1”. As a result, the sales management device 60 determines that the result in ACT 1 is YES and the result in ACT 2 is NO. Accordingly, the final registration processing is executed. By this final registration processing, the customer ID of the customer M1 is specified as the customer ID of the purchaser. Then, a purchase record indicating that one piece of the merchandise 81 is purchased, is registered in a purchase list 632A in which the customer ID is set. Both of the temporary registration flag F1 and the deletion flag F2 of the purchase record are set to “0”. That is, the purchase record is a record for final registration and not a record targeted for deletion. The purchase list 632A indicates the purchase list 632 of the customer M1.

For example, in FIG. 6, it is assumed that the customer M2 performs a purchase action of picking up two pieces of merchandise 82 displayed at the second display place 71B almost at the same time as the purchase action of the customer M1. In such a case, two types of variation data 90B and 90C are output from the monitoring device 30 to the sales management device 60. The increase or decrease flag, the place code, the merchandise code, and the increased or decreased number of merchandise of the variation data 90B match those of the variation data 90A. However, the number of acting customers is set to “2”. The increase or decrease flag, the place code, and the number of acting customers of the other variation data 90C match those of the variation data 90B. However, the merchandise code thereof is the merchandise code of the merchandise 82, and the increased or decreased number of merchandise is “2”. The difference between the increase or decrease time of the variation data 90B and the increase or decrease time of the variation data 90C is shorter than the threshold time.

In such a case, the sales management device 60 determines that the results in all of ACT 1 to ACT 4 are YES. Accordingly, the final registration processing is executed. By this final registration processing, regarding the variation data 90B, the customer ID of the customer M1 near the first display place 70A is specified as the customer ID of the purchaser. Then, in the purchase list 632A of the customer M1, the purchase record indicating that one piece of merchandise 81 is purchased is registered. Both the temporary registration flag F1 and the deletion flag F2 of the purchase record are “0”. That is, the purchase record is the record for final registration, not the record targeted for deletion.

The variation data 90B is processed similarly to the variation data 90A. That is, in the sales management device 60, the results in all of ACT 1 to ACT 4 are determined as YES. Accordingly, the final registration processing is executed. By this final registration processing, the customer ID of the customer M2 near the second display place 70B is specified as the customer ID of the purchaser. Then, in a purchase list 632B in which the customer ID is set, the purchase record indicating that two pieces of merchandise 82 are purchased is registered. Both the temporary registration flag F1 and the deletion flag F2 of the purchase record are “0”. That is, the purchase record is the record for final registration, not the record targeted for deletion. The purchase list 632B indicates the purchase list 632 of the customer M2.

On the other hand, as illustrated in FIG. 7, it is assumed that the customer M2 performs a purchase action of picking up one piece of merchandise 81 displayed at the first display place 71A almost at the same time as the purchase action described above of the customer M1. In such a case, one type of variation data 90D is output from the monitoring device 30 to the sales management device 60. The increase or decrease flag, the merchandise code, the place code, and the number of acting customers of the variation data 90D match those of the variation data 90B. However, the increased or decreased number of merchandise is “2”.

In such a case, in the sales management device 60, the results in all of ACT 1 to ACT 3 are determined to be YES, but the result in ACT 4 is determined to be NO. Accordingly, the temporary registration processing is executed. By this temporary registration processing, both the customer ID of the customer M1 and the customer ID of the customer M2 are specified as the customer ID of the purchaser. Then, purchase records when purchasing two pieces of merchandise 81 are respectively registered in the purchase list 632A of the customer M1 and the purchase list 632B of the customer M2. The temporary registration flag F1 of the purchase record is “1” and the deletion flag F2 thereof is “0”. That is, the purchase record is the record for temporary registration. The purchase record is not the record targeted for deletion.

In such a case, a voice sound for notifying a registration error is output from the speaker 303 provided in the vicinity of the first display place 71A and the second display place 71B. Accordingly, the customers M1 and M2 can recognize that an error occurred in registering the obtained merchandise 81.

In FIG. 7, when the customer M3 purchases two pieces of merchandise 82 from the second display place 71B at the same time as the customers M1 and M2, two types of variation data 90E and 90F are output from the monitoring device 30 to the sales management device 60. The increase or decrease flag, the merchandise code, the place code, and the increased or decreased number of merchandise of the variation data 90E match those of the variation data 90D. However, the number of acting customers is “3”. The increase or decrease flag, the merchandise code, the place code, and the increased or decreased number of merchandise of the other variation data 90F match those of the variation data 90B. However, the number of acting customers is “3”.

As such, since both the variation data 90E and the variation data 90F have the number of acting customers of “3”, the sales management device 60 determines that the result in ACT 3 is NO. Accordingly, the temporary registration processing is executed. By this temporary registration processing, the customer ID of the customer M1, the customer ID of the customer M2, and the customer ID of the customer M3 are all specified as the customer ID of the purchaser. Then, in the purchase list 632A of the customer M1 and the purchase list 632B of the customer M2, purchase records when purchasing two pieces of merchandise 81 are respectively registered. The temporary registration flag F1 of the purchase record is “1” and the deletion flag F2 thereof is “0”. That is, the purchase record is the record for the temporary registration, not the record targeted for deletion.

Similarly, in a purchase list 632C in which the customer ID of the customer M3 is set, a purchase record indicating that two pieces of the merchandise 82 are purchased is registered. The temporary registration flag F1 of the purchase record is “1” and the deletion flag F2 thereof is “0”. That is, the purchase record is the record for the temporary registration, not the record targeted for deletion. The purchase list 632C indicates the purchase list 632 of the customer M3.

Additionally, a voice sound for notifying the registration error is output from the speaker 303 provided in the vicinity of the first display place 71A and the second display place 71B. Accordingly, the customer M1, the customer M2, and the customer M3 can recognize that an error occurred in registering the obtained merchandise 81 and 82.

Now, the customer M1, the customer M2, and the customer M3, who confirmed the voice sound notifying the registration error, return the obtained merchandise 81 and 82 to the original display places 71A and 71B, respectively. When the merchandise is returned to the display place, the variation data 90, when the increase or decrease flag is “1”, that is, the measurement value increases, is output from the monitoring device 30 to the sales management device 60. Therefore, next, the operation of the sales management device 60 performed when the variation data 90 with the increase or decrease flag being “1” is received will be described.

Upon receipt of the variation data 90 via the communication interface 64, the processor 61 checks the increase or decrease flag of the variation data 90, as ACT 1. In such a case, since the increase or decrease flag is “1”, the processor 61 determines that the result in ACT 1 is NO, and proceeds to ACT 15. The processor 61 executes merchandise return processing, as ACT 15.

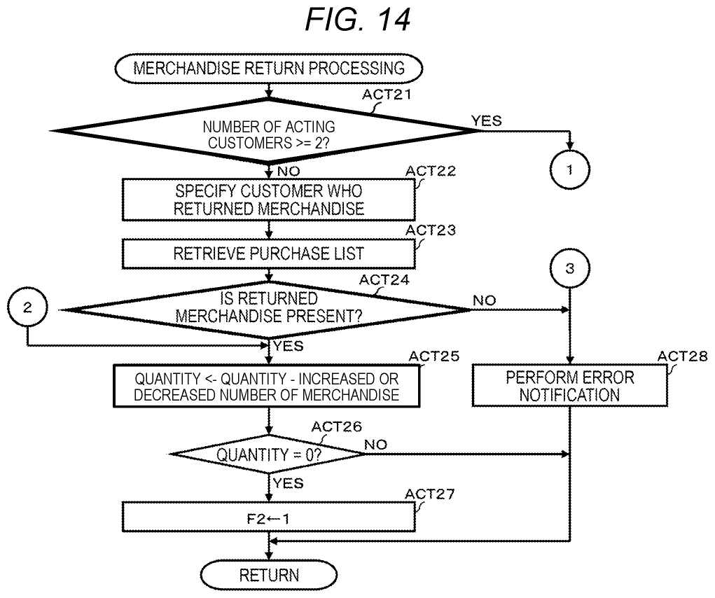

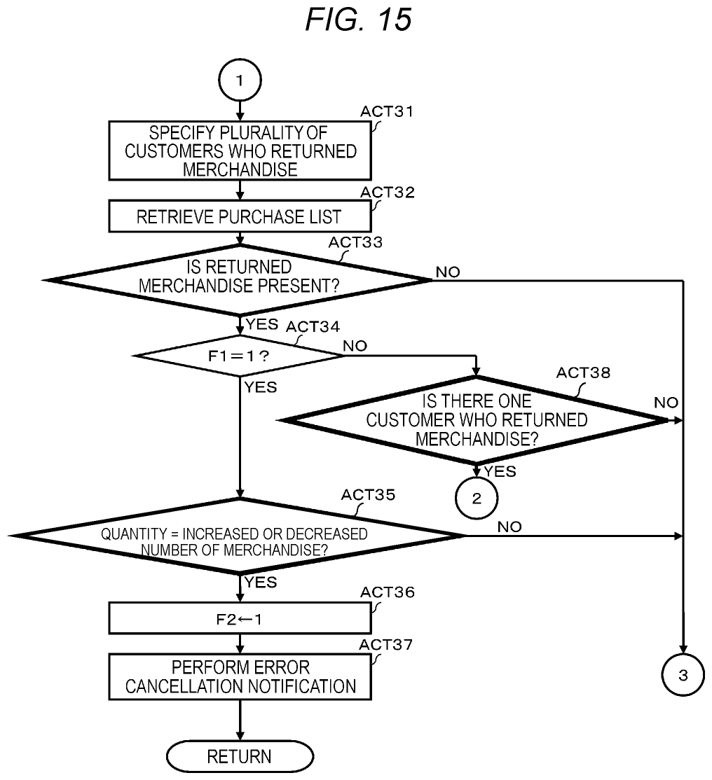

FIG. 14 and FIG. 15 are flowcharts of the merchandise return processing. When the merchandise return processing is started, the processor 61 checks whether the number of acting customers in the variation data 90 is two or more, as ACT 21 in FIG. 14. When the number of acting customers is one, the processor 61 determines that the result in ACT 21 is NO and proceeds to ACT 22. The processor 61 specifies the customer ID of the customer who returned merchandise, as ACT 22. This specifying processing is the same as the specifying processing of the customer ID of the purchaser described as processing of ACT 5.

When the customer ID of the customer who returned merchandise is specified, the processor 61 retrieves the purchase list 632 in which the customer ID is set, as ACT 23. Then, the processor 61 checks whether the purchase record including the merchandise code included in the variation data 90 is registered in the purchase list 632, as ACT 24. When the corresponding purchase record is registered in the purchase list 632, the processor 61 determines that the result in ACT 24 is YES, and proceeds to ACT 25. The processor 61 subtracts the increased or decreased number of merchandise included in the variation data 90 from the quantity of the purchase record, as ACT 25. Then, the processor 61 checks whether the quantity of the purchase record after subtraction becomes 0, as ACT 26.

If the quantity of the purchase record after subtraction is zero, the processor 61 determines that the result in ACT 26 is YES, and proceeds to ACT 27. The processor 61 updates the deletion flag of the purchase record to “1”, as ACT 27. With this configuration, the purchase record becomes a record targeted for deletion.

On the other hand, when the quantity of the purchase record after subtraction is one or more, the processor 61 determines that the result in ACT 26 is NO, and skips processing of ACT 27. Accordingly, the quantity of the number of purchase records is subtracted by the number of returned merchandise, and is not a record targeted for deletion.

Thus, the processor 61 ends the merchandise return processing.

When the purchase list 632 of the customer who returned merchandise is retrieved but the corresponding purchase record is not detected, the processor 61 determines that the result in ACT 24 is NO, and proceeds to ACT 28. The processor 61 performs error notification processing, as ACT 28. That is, the processor 61 outputs a voice signal for error notification, which is transmitted to the monitoring device 30 via the communication interface 64. With this configuration, in the monitoring device 30, a voice sound for notifying an error is synthesized by the voice synthesis circuit 38, and the voice sound is output from the speaker 303.

If the purchase record of the returned merchandise cannot be detected from the purchase list 632 of the customer who returned merchandise, it is considered that an error that the purchase record was not registered at the time when the returned merchandise was purchased in the first place occurred. Therefore, by processing of ACT 28, a voice sound notifying the customer that checkout will be performed with the non-self-service checkout machine 40A because a registration error occurs, is output from the speaker 303.

On the other hand, when the number of acting customers of the variation data 90 is two or more, the processor 61 determines that the result in ACT 21 is YES, and proceeds to ACT 31 in FIG. 15. The processor 61 specifies the customer IDs of the customers who returned merchandise as many as the number of acting customers, as ACT 31. This processing is the same as the processing of specifying the customer IDs of the plurality of purchasers described as processing of ACT 9.

When the customer IDs of the customers who returned merchandise are specified, the processor 61 retrieves each of the purchase lists 632 in each of which the customer ID of each customer who returned merchandise is set, as ACT 32. Then, the processor 61 checks whether the purchase record including the merchandise code included in the variation data 90 is registered in the purchase list 632 of at least one customer who returned merchandise, as the ACT 33. When the purchase record corresponding to the purchase list 632 of at least one customer who returned merchandise is registered, the processor 61 determines that the result in ACT 33 is YES, and proceeds to ACT 34. The processor 61 examines the temporary registration flag of the purchase record, as ACT 34.

When the temporary registration flag is “1”, that is, the purchase record is the record for temporary registration, the processor 61 determines that the result in ACT 34 is YES, and proceeds to ACT 35. The processor 61 checks whether the quantity of the purchase records matches the increased or described number of merchandise of the variation data 90, as ACT 35.

When the quantity of the purchase records matches the increased or decreased number of merchandise, the processor 61 determines that the result in ACT 35 is YES, and proceeds to ACT 36. The processor 61 updates the deletion flag of the purchase record to “1”, as ACT 36. That is, the purchase record is set as a record targeted for deletion. Furthermore, the processor 61 performs error cancellation notification processing, as ACT 37. That is, the processor outputs a voice signal for notifying the error cancellation, which is transmitted to the monitoring device via the communication interface 64. With this configuration, in the monitoring device 30, the voice sound for notifying the error cancellation is synthesized by the voice synthesis circuit 38, and the voice sound is output from the speaker 303.

The voice sound for notifying the error cancellation contains a message for notifying the customer that the registration error is cancelled. For example, a message such as “An error is cancelled. Please purchase merchandise one piece by one piece.” is output from the speaker 303.

Thus, the merchandise return processing ends.

On the other hand, when the temporary registration flag F1 of the purchase record is not “1”, the processor 61 determines that the result in ACT 34 is NO, and proceeds to ACT 38. The processor 61 checks whether there is only one purchase list 632 including purchase records for returned merchandise, as ACT 38. When there is only one purchase list 632 including the purchase records for returned merchandise, it is determined that the customer identified with the customer ID of the purchase list 632 returned the merchandise. Therefore, the processor 61 determines that the result in ACT 38 is YES, and proceeds to ACT 25 in FIG. 14. Then, the processor 61 executes processing of ACT 25 to ACT 27 similarly as described above.

In contrast, when two or more purchase lists 632 including purchase records for returned merchandise exist, a correct customer who returned merchandise cannot be specified. In such a case, the processor 61 determines that the result in ACT 38 is NO, and proceeds to ACT 28 in FIG. 14. Even when the purchase records corresponding to the purchase lists 632 of all the customers who returned merchandise are not registered or the quantity of the purchase records does not match the increased or decreased number of merchandise of the variable data 90, the correct customer who returned merchandise cannot be specified. That is, when it is determined that the result in ACT 33 is NO or when it is determined that the result in ACT 35 is NO, the processor 61 proceeds to ACT 28 in FIG. 14. The processor 61 performs the error notification processing, as ACT 28.

For example, as illustrated in FIG. 7, when two customers M1 and M2 purchase the merchandise 81 one piece by one piece almost at the same time from one display place 71A, as described above, the temporary registration processing is executed in the sales management device 60. That is, the purchase records obtained by purchasing two pieces of merchandise 81 are respectively registered in the purchase list 632A of the customer M1 and the purchase list 632B of the customer M2. Then, the temporary registration flags of these purchase records become “1”. A voice sound for notifying the registration error is output from the speaker 303. Accordingly, the customer M1 and the customer M2 will return the merchandise 81 to the display place 71A in response to the voice sound.

In such a case, when the customer M1 and the customer M2 return the merchandise 81 to the display place 71A almost at the same time, variation data 90G having the increase or decrease flag of “1”, the increased or decreased number of merchandise of “2”, and the number of acting customers of “2” is output from the monitoring device 30 to the sales management device 60. As a result, in the sales management device 60, it is determined that the result in ACT 21 is YES, and also determined that the results in ACT 33 to ACT 35 are YES, and processing of ACT 36 and ACT 37 is executed. As a result, the temporarily registered purchase record becomes a deletion target. Then, a voice sound for notifying the error cancellation is output from the speaker 303. Accordingly, the customers M1 and M2 will purchase the merchandise 81 in an order set according to the voice sound. Thus, purchase data of the merchandise 81 is finally registered in each of the purchase lists 632 of the customer M1 and the customer M2.

For example, when only one customer M1 returns the merchandise 81 to the display place 71A, the registration error is not cancelled because it is determined that the result in ACT 35 is NO. As a result, both the customer M1 and the customer M2 will have to perform checkout with the non-self-service checkout machine 40A.

Here, through ACT 31 to ACT 37, after the notification of the registration error, when an increase in the number of merchandise is detected in the display place where the decrease in the number of the merchandise has been previously detected, the customer is notified of the resumption of purchase action via the speaker 303.

As described above, for example, when two customers M1 and M2 take a piece of merchandise 81 displayed at the same display place 71A at almost the same time, purchase data indicating that two pieces of merchandise 81 have been purchased (or selected for purchase) is temporarily registered in both the purchase list 632A of the customer M1 and the purchase list 632B of the customer M2, and the registration error is notified.

Therefore, when the customers M1 and M2 both return the pieces of merchandise 81 to the display place 71A in quick succession, the purchase data temporarily registered in the purchase list 632A and the purchase list 632B can be deleted.

After that, when customer M1 purchases one piece of merchandise 81 from the display place 71A, the purchase data indicating that one piece of merchandise 81 is purchased is finally registered in the purchase list 632A. Subsequently, when the other customer M2 purchases one piece of merchandise 81 from the display place 71A, the purchase data indicating that the one piece of merchandise 81 is purchased is finally registered in the purchase list 632B.

A customer whose purchase data registered in the purchase list 632 is all finally registered can settle the commercial transaction with the self-service checkout machine 40B. Even when the temporarily registered purchase data is still included, the transaction can be settled with the self-service checkout machine 40B when the temporary purchase data has already been set as a deletion target. In contrast, a customer with at least one piece of temporarily registered purchase data, which is not yet set as a deletion target, cannot settle the commercial transaction with the self-service checkout machine 40B. Such a customer will be required to settle the commercial transaction at the non-self-service checkout machine 40A.

Accordingly, it is possible to provide the sales management system 1 and the sales management device 60 of this system that can manage sales data with high reliability even when identification of a purchaser is difficult.

The invention is not limited to the embodiments described above.

For example, in the embodiments described above, one set of the camera 301, the first weight sensor 302A, the second weight sensor 302B, and the speaker 303 are disposed in correlation with two merchandise display places that are close together. In this regard, by increasing the number of weight sensors, the weight sensors can be disposed in correlation with three or more merchandise display places. The plurality of display places may not be adjacent to each other on the floor surface. The plurality of display places may be disposed so as to be correlated with a plurality of merchandise display places having step above and below.

In the embodiments described above, the signal for notifying the registration error is output to the monitoring device 30. The output destination of the signal is not limited to the monitoring device 30. For example, a terminal operated by a store clerk may be the output destination of the signal. Thus, an error notification is issued from the terminal, and thus the store clerk can appropriately deal with the error. Instead of such a terminal, a terminal such as a smartphone carried by the customer may be the output destination of the signal. Thus, the notification of the registration error is directly transmitted to the customer, and thus the customer can perform a merchandise return operation for cancelling the error.

While certain embodiments have been described, these embodiments have been presented by way of example only, and are not intended to limit the scope of the inventions. Indeed, the novel methods and systems embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sales management system, comprising:
a monitoring device configured to:
determine one or more items that have been taken by one or more customers in a particular area of a store,
capture an image of said one or more customers, and
transmit data of the captured image and the determined items; and
a sales management device configured to:
upon receipt of the data from the monitoring device, identify one or more customers in the image,
when one customer is in the image, register the item indicated by the data as an item to be purchased by the customer, and
when two or more customers are in the image, issue an error signal that causes the monitoring device to output a registration error warning.

2. The sales management system according to claim 1, wherein the sales management device is further configured to, when two customers are in the image and two different items have been taken by the customers, register each of the two different items as an item to be purchased by both the customers.

3. The sales management system according to claim 2, wherein the sales management device is further configured to issue the error signal when the two different items are of a same type.

4. The sales management system according to claim 3, wherein the registration error warning is output by playing a voice sound that instructs returning of the two different items.

5. The sales management system according to claim 4, wherein the voice sound is output from a speaker installed in the particular area.

6. The sales management system according to claim 4, wherein the sales management device is further configured to, when the items are returned to the particular area of the store after the output of the registration error warning, issue a notification signal that causes the monitoring device to play a voice sound that instructs resuming of shopping.

7. The sales management system according to claim 2, wherein the sales management device is further configured to issue the error signal regardless of types of the items that have been taken when three or more customers are in the image.

8. The sales management system according to claim 7, wherein the sales management device is further configured to, after the issuance of the error signal, provisionally register each item that has been taken in association with the customer.

9. The sales management system according to claim 8, wherein the sales management device is further configured to cancel the provisional registration when each item that has been provisionally registered is returned to the particular area.

10. The sales management system according to claim 9, wherein the sales management device is further configured to prohibit the customer associated with the provisionally registered item from performing checkout using a self-service checkout device until the provisional registration is cancelled.

11. A sales management device, comprising:
a network interface configured to communicate with a monitoring device installed in a store; and
a processor configured to:
acquire, from the monitoring device via the network interface, data for one or more items that have been taken by one or more customers in a particular area of the store and an image of the one or more customers,
identify the one or more customers in the image,
when one customer is in the image, register the item indicated by the data as an item to be purchased by the customer, and
when two or more customers are in the image, issue an error signal that causes the monitoring device to output a registration error warning.

12. The sales management device according to claim 11, wherein the processor is further configured to, when two customers are in the image and two different items have been taken by the customers, register each of the two different items as an item to be purchased by both the customers.

13. The sales management device according to claim 12, wherein the processor is further configured to issue the error signal when the two items are of a same type.

14. The sales management device according to claim 13, wherein the registration error warning is output by playing a voice sound that instructs returning of the two different items.

15. The sales management device according to claim 14, wherein the voice sound is output from a speaker installed in the particular area.

16. The sales management device according to claim 14, wherein the processor is further configured to, when the items are returned to the particular area of the store after the output of the registration error warning, issue a notification signal that causes the monitoring device to play a voice sound that instructs resuming of shopping.

17. The sales management device according to claim 12, wherein the processor is further configured to issue the error signal regardless of types of the items that have been taken when three or more customers are identified in the image.

18. The sales management device according to claim 17, wherein the processor is further configured to, after the issuance of the error signal, provisionally register each item that has been taken in association with the customer.

19. The sales management device according to claim 18, wherein the processor is further configured to cancel the provisional registration when each item that has been provisionally registered is returned to the particular area.

20. A control method of a sales management device configured to communicate with a monitoring device, the method comprising:
receiving, from a monitoring device, data for one or more items that have been taken by one or more customers in a particular area of the store and an image of said one or more customers;
identifying the one or more customers in the image;
registering the item indicated by the data as an item to be purchased by the identified customer when just one customer is in the image; and
issuing an error signal that causes the monitoring device to output a registration error warning when two or more customers are in the image.
